(19) United States
(12) Patent Application Publication
(10) Pub. No.: US 2004/0209100 A1
(43) Pub. Date: Oct. 21, 2004

(54) Protective masking film

(75) Inventors: Julien Lefebvre, Le Gardeur (CA); Jose Garrocho, Blainville (CA); Ludovic Leplatois, Montreal (CA)

Correspondence Address: STERNE, KESSLER, GOLDSTEIN & FOX PLLC, 1100 NEW YORK AVENUE, N.W., WASHINGTON, DC, 20005, US

(73) Assignee: Marko I.R.D.C. Inc.

(21) Appl. No.: 10/656,836

(22) Filed: Sep. 8, 2003

Related U.S. Application Data
(60) Provisional application No. 60/472,111, filed on May 21, 2003.

(30) Foreign Application Priority Data
Sep. 6, 2002 (CA) 2,401,794

(51) Int. Cl. B32B 27/32

(52) U.S. Cl. 428/515; 428/523

(57) ABSTRACT

The present invention provides a protective masking film that can adhere to and provide protection to the surface of a substrate, without the use of an adhesive. The masking film comprises two or more layers of which one of the outer layers is formed from Mxsite™ and the other outer layer formed from a polymer or polymers other than Mxsite™. The masking film is retackable. Also provided are compositions and methods for producing the protective masking film.

### FIELD OF THE INVENTION

The present invention pertains to the field of masking films and more particularly to the field of protective masking films.

### BACKGROUND

Masking films are used in numerous applications as a protective coating or covering for surfaces of various substrates, particularly smooth surfaces, such as acrylics, glass, polished or painted metals, glazed ceramics, and other smooth, relatively rigid surfaces. The masking film is applied to the surface to be protected and acts as a physical barrier to prevent scratching, scuffing and marring of the surface. Protection provided by masking films is particularly useful while these surfaces are being printed, transported, or otherwise handled prior to use.

In one example of a typical application of masking films, a polyolefin film to be used as a protective layer is applied to the surface of a substrate, which is a polymeric sheet, during the sheet manufacturing process, post extrusion but before the cutting operation. Polyolefin films commonly used in such a process are generally comprised of a three layer film with one layer being comprised of i) an ethylene vinyl acetate (EVA; 6-18% VA), and treated to 40 dynes of surface energy; ii) a copolymer of ethylene and acrylic acid (such as Primacor™ EAA sold by Dow or Nucrel™ EAA sold by DuPont); or iii) a copolymer of ethylene and ethylene ethyl acrylic acid salt (such as Surlyn™ sold by DuPont) with the other layers consisting of polyethylene (low density polyethylene (LDPE), linear low density polyethylene (LLDPE) or high density polyethylene (HDPE)). Alternatively, an embossed film such as disclosed in U.S. Pat. Nos. 6,326,081 and 6,040,046 has been utilised. This technology shapes the film into small suction cups, which create a differential pressure on either side of the film in order to improve the adhesion of the film to the smooth sheet.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a protective masking film. In accordance with an aspect of the present invention, there is provided an adhesiveless masking film, comprising a first outer layer consisting of Mxsite™ and a second outer layer that does not contain Mxsite™, wherein the first outer layer of the film is adapted for retackably adhering to a surface of a substrate.

In accordance with another aspect of the present invention, there is provided a three layer, adhesiveless masking film, wherein one outer layer is formed from Mxsite™ and the second outer layer is formed from a polymer or polymers other than Mxsite™, and wherein the film is retackable.

In accordance with another aspect of the present invention, there is provided a use of Mxsite™ in the manufacture of a protective masking film having at least 2 layers, wherein only one of the outer layers of the film comprises Mxsite™.

In accordance with another aspect of the present invention, there is provided a method for measuring adhesion of a film to a substrate comprising the steps of: laminating the film to a surface of the substrate to produce a laminated film composite; cutting a strip of the laminated film composite having a predetermined length; marking the strip of laminated film composite at regular intervals along the length of the strip; attaching a weight to the film at one end of the strip; allowing the film to peel off of the substrate under constant stress of a weight; determining time required for the film to be displaced from the composite by measuring the time for the film to peel off the substrate to each mark on the strip; calculating a cumulative peeling velocity by dividing the length of total displacement of the film with the sum of the times measured in previous step, wherein the strength of adhesion of the film to the substrate is a function of the cumulative peeling velocity.

In accordance with another aspect of the present invention, there is provided an article of manufacture comprising a protective masking film adhered to a surface of a substrate, wherein the protective masking film is adhesiveless, retackable and comprises at least 2 layers including one outer layer that is formed from Mxsite™ and is in contact with the surface of the substrate and a second outer layer that is formed from a polymer or polymers other than Mxsite™.

### BRIEF DESCRIPTION OF THE FIGURES

FIG. 1 depicts a 3 layer masking film in accordance with one embodiment of the present invention.

FIG. 2 depicts a typical assembly for lamination of a masking film according to one embodiment of the present invention to a polymeric substrate, such as a heavy gauge sheet.

FIG. 3 graphically depicts the difference in adhesion strength (Psi) exhibited by different films as measured using a modified block-reblock tester. Adhesion strength above the adhesion level marked with the first line is superior to the block-reblock tester capacity. The tackiness threshold of 0.01 Psi is indicated with the second line. Block-reblock tester capacity limit - - - - - - Tackiness threshold

[symbol]

FIG. 4 graphically depicts the effect of laminating pressure on adhesion strength exhibited by the masking film produced as described in Example 1, as measured using a modified block-reblock tester. Adhesion strength above the adhesion level marked with the first line is superior to the block-reblock tester capacity. The tackiness threshold of 0.01 Psi is indicated with the second line. The pressures tested were 14.5 lbf (♦), 10.81 lbf (▪), 4.5 lbf (▴) and no pressure (●). Block-reblock tester capacity limit - - - - - - Tackiness threshold

[symbol]

FIG. 5 graphically depicts the results of peeling velocity testing in the transversal direction.

FIG. 6 graphically depicts graphically depicts the results of peeling velocity testing in the longitudinal direction.

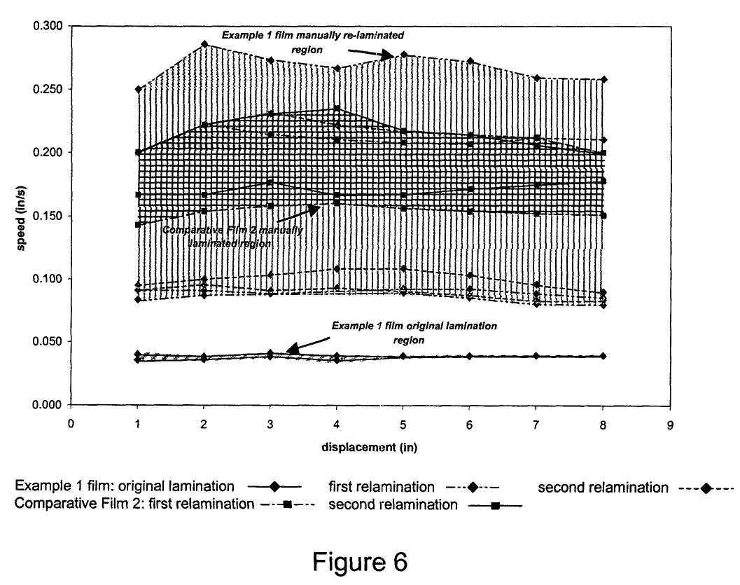

### DETAILED DESCRIPTION OF THE INVENTION

In accordance with the present invention there is provided a masking film that can adhere to and provide protection to a surface of a substrate, without the need for a separate adhesive layer. The masking film of the present invention exhibits high adhesion strength to other surfaces, even at low application temperatures, does not leave residue on the surface following removal and is retackable without the use of adhesive. Retackability, as used herein, refers to the ability of the film to be removed from the surface of the substrate to be protected and subsequently reapplied without loss, or with minimal loss, of adhesion strength. The polymeric substrate may be a polymeric substrate such as polycarbonate sheet, polyester sheet, copolyester sheet, ABS sheet and acrylic sheet. Alternatively, the substrate may be glass or any other substrate having a smooth, matte, embossed, corrugated or other surface.

Components of the Masking Film

The protective masking film of the present invention comprises at least 2 layers and may be produced using a blown or cast film extrusion line as described in more detail below. The masking film of the present invention comprises an outer layer that consists of a polymer that is manufactured and sold by Eastman Chemical Company under the tradename Mxsite™, hereinafter referred to as “Mxsite™”. The second outer layer does not comprise Mxsite™

Mxsite™ is a polyethylene cling resin that is sold by Eastman Chemical Company for use in the skin layers of cast stretch film. Mxsite™ polymers, including Mxsite™ 78102 and 78104, are advertised as providing a very aggressive cling force in both stretched and unstretched conditions. It has now surprisingly been found that Mxsite™ is useful in the manufacture of protective masking films.

In one embodiment of the present invention, the inner layer(s) of the masking film, if present, comprise a polymer selected from the group comprising Mxsite™, low density polyethylene, linear low density polyethylene (LLDPE), including a linear low density polyethylene copolymer where the copolymer is a linear or branched carbon compound consisting of no less than 3 carbon atoms and up to 18 carbon atoms or a mixture thereof, a metallocene catalysed polyethylene, a high density polyethylene, a medium density polyethylene and any combination thereof. When used in combination the polymers may be present in any range of percentages.

The composition of the second outer layer and the middle, or core, layers, if present, are designed based on the use of the masking film. For example, the layer thicknesses and compositions can be selected to optimize cost and application-specific properties or output. In the case of a multi-layer film, generally the more expensive polymers are in the outer layer and the inexpensive polymers are in the core. Therefore, the inner and outer layer thicknesses are such that at least a 10% layer thickness is maintained. Given the limitations of most currently used equipment, which result in a 5% range of error, a 15-20% layer thickness in the inner and outer layers is preferred, although this may be reduced as equipment is improved. In addition, as would be appreciated by a worker skilled in the art, it is important to select the composition of the outer and core layers to ensure a balanced film structure in order to prevent the film from curling onto itself, which can be caused by a difference in orientation between the layers.

The second outer layer is generally selected for optimization of output, however specific attributes may be required for certain applications. For example, in some instances a releasable film (i.e. the film may be released from the topsheet) is required, in which case a material that contains slip additive is used in the second outer layer.

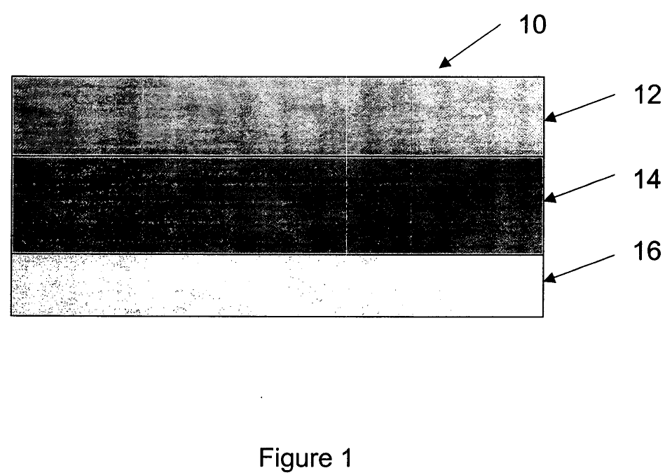

A specific embodiment of the present invention is depicted in FIG. 1, in which the masking film (10) comprises 3 layers, referred to herein as Layer A (12), Layer B (14) and Layer C (16). In use, Layer A (12) will contact the surface to be protected. Layer A (12) comprises 100% Mxsite™. Layer A can be between 5-90% of the total thickness of the film, or advantageously between 15-33%.

Layer B (14), the middle layer of the film, comprises 100% linear low density polyethylene copolymer of hexane. Alternatively, Layer B (14) comprises a polymer selected from the group comprising Mxsite™, low density polyethylene, linear low density polyethylene (LLDPE), including a linear low density polyethylene copolymer where the copolymer is a linear or branched carbon compound consisting of no less than 3 carbon atoms and up to 18 carbon atoms or a mixture thereof, a metallocene catalysed polyethylene, a high density polyethylene, a medium density polyethylene and any combination thereof. Layer B (14) optionally comprises a colorant such as, but not limited to, titanium dioxide, phthalate blue, carbon black, iron oxide. Layer B (14) can be between 0-90% of the total thickness of the film, or, advantageously, between 50-80%.

Layer C (16), the second outside layer of the film, comprises 100% low density polyethylene or a polymer selected from the group comprising linear low density polyethylene (LLDPE), including a linear low density polyethylene copolymer where the copolymer is a linear or branched carbon compound consisting of no less than 3 carbon atoms and up to 18 carbon atoms or a mixture thereof, a metallocene catalysed polyethylene, a high density polyethylene, a medium density polyethylene and any combination thereof. When used in combination the polymers may be present in any range of percentages. Layer C (16) does not contain Mxsite™. Layer C (16) is optionally treated using a corona or flame treatment to increase the surface tension of the film and be printed. Layer C (16) can be between 0-90% of the total thickness of the film, or, advantageously, between 15-33%.

In a specific embodiment of the present invention, the masking film comprises three layers; the first outer layer (Layer A) consists of Mxsite™, the middle layer (Layer B) comprises Eastman Hifor™ and the second outer layer (Layer C) comprises Dow LDPE 494 or Eastman LDPE 969. Eastman Hifor™ may be replaced with any LLDPE, LDPE, metallocene polyethylene (mPE), PP (i.e. polypropylene homopolymer, polypropylene copolymer of ethylene or random copolymer of polypropylene and ethylene) or PP impact copolymer, which is a copolymer of polypropylene and ethylene where the ethylene amount is at least 10%.

Layer C optionally includes a slip agent, such as, but not limited to, euricamide. When used, the slip agent is present in an amount of greater than 200 ppm.

Additional materials may be added to one or more of the layers of the masking film in order to provide certain desired characteristics, including, for illustrative purposes only, roughness, abrasion resistance, printability, writeability, opacity and colour. Such fillers are well known in the industry and include, for illustrative purposes only, calcium carbonate (abrasion resistance), mica (printability), titanium dioxide (color and opacity) and silicon dioxide (roughness).

Manufacture of the Masking Film

The masking film of the present invention can be produced using a blown or cast film extrusion process and/or using any coating processes such as extrusion coating, spray coater technology, or an electron beam (EB), ultraviolet (UV) or other type of laminator.

Typical blown film extrusion lines have been employed, using standard equipment and techniques known to workers skilled in the art, to manufacture the masking film of the present invention. In a specific embodiment, the 2 or more layers of the masking film of the present invention are coextruded using any coextrusion process known in the art. The use of coextrusion allows for the relatively simple and easy manufacture of a multilayered masking film composed of distinct layers, each performing specific functions. Although one embodiment of the present invention includes coextrusion of the masking film of the present invention, it is noted that the masking film can be bilayered or multilayered and that, regardless of form, the masking film can be produced using any other suitable method, if desired, as would be well understood by a worker skilled in the relevant art.

In one embodiment of the present invention, the film is formed as a tube. In this case the flattened masking film is trimmed at each extremity to modify the shape of the flattened sheet from the tube. In a specific embodiment, a three layer masking film is formed as a tube and Layer A of the three layer film is the inside layer of the tube.

The film can be printed on if desired, however, the printing process must be done within 24 hours of the film extrusion so that no build up of the Mxsite™ occurs on the printing plates.

In order to confirm the adhesion properties of the masking film of the present invention, twenty-four hours following extrusion, a sample of the film is applied using finger pressure to a polycarbonate sheet. So that the test accurately mimics commercial application of the masking film, it is important to ensure that the sheet is free and clear of any smudges or dust. The film is then removed and the surface is visually examined for evidence of residue. The film is then retacked onto the sheet and the peel strength is verified. The masking film of the present invention does not leave residue on the surface and exhibits good peel strength, initially and following retacking.

The adhesion strength of the film can also be determined by finding the cumulative peeling velocity of the film from the substrate.

Use of the Masking Film

One aspect of the present invention provides the use of the masking film of the present invention in adhering to and protecting a surface of a substrate. Examples of substrates that can be protected using the masking film of the present invention include, but are not limited to, polycarbonate (PC), acrylic, also known as poly methyl methacrylate (PMMA), PS, acrylonitrile butadiene styrene (ABS), polyester (PET), glycol modified copolyester (PET-G) and glass. The surface to be protected can be smooth, corrugated or otherwise, provided that it is possible to bring the Mxsite™ outer layer of the masking film into intimate contact with the surface of the substrate.

In use, the surface of the outer layer of the film, which consists of Mxsite™, is brought into intimate contact with the surface to be protected. Any one or more of a number of conventional application methods can be used to bring the surface of the first layer of the masking film into intimate contact with the surface of the substrate to be protected by the masking film. Typically, the masking film will be applied to the surface to be protected via a nip roll or similar system through which the masking film and the substrate surface to be protected are passed simultaneously. If desired, the resulting article can be passed through compression rolls or the like for further processing. Any other suitable method for combining the masking film with the substrate surface to be protected can be used, if desired.

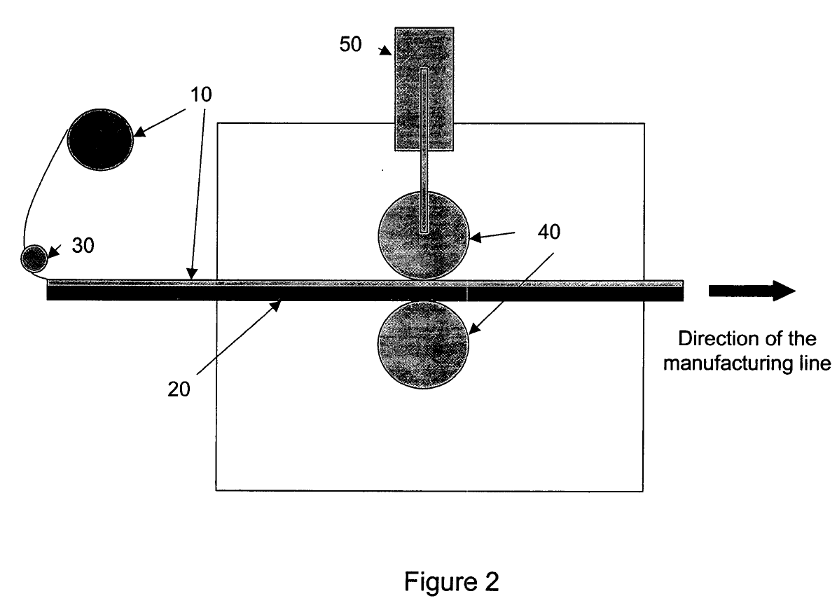

In a specific embodiment of the present invention, the masking film is applied using a typical lamination assembly as depicted in FIG. 2. Along a line a substrate to be protected, the masking film (10) is guided, using an idler roll (30), into intimate contact with the surface of a substrate (20), for example in the form of a heavy gauge sheet. The masking film and substrate are passed between nip rolls (40) simultaneously. The nip rolls provide a predetermined pressure in order to facilitate uniform adhesion of the masking film to the substrate. As depicted in FIG. 2, an air piston (50) can be used to generate the predetermined pressure.

The masking film of the present invention is can be applied to the surface to be protected at lower application temperatures than required for standard lamination processes. In particular, the masking film can be applied at normal room temperatures without the use of any heat. For example, Comparative films 2, 3 and 4 referred to in Example 2 require application to a substrate at a warm temperature, meaning that the films would have to be heated to at least 80° C. for any adhesion. An observed benefit of cold (or non-heated) adhesion is improved surface appearance as marring of the surface is minimised while good control of adhesion is maintained. Furthermore, the film of the present invention is not susceptible to shrinkage during the application process, in part because high application temperatures are avoided and, in part, because these films do not shrink. A hot oil bath (e.g. at 250° C.) shrink test may be used to confirm this property of the film of the present invention. This results in better protection of the surface since the film will adhere throughout the surface, including near its edges.

The present invention also includes articles of manufacture comprising a masking film of the present invention. Such articles of manufacture include a bilayer or multilayer film, in which one outer layer comprises or consists of Mxsite™ and the other does not, retackably adhered to a surface of a substrate to be protected.

To gain a better understanding of the invention described herein, the following examples are set forth. It should be understood that these examples are for illustrative purposes only. Therefore, they should not limit the scope of this invention in any way.

### EXAMPLES

### Example 1

### Three-Layer Masking Film

A three layer masking film was prepared having a first outer layer consisting of 100% Mxsite™, a middle layer consisting of 100% Eastman Hifor™ and a second outer layer consisting of 100% LDPE Dow 494. The film was prepared by blown film coextrusion using standard PE extrusion conditions, melt temperature of 420° F., pressure of 4000 psi, blow up ratio of 2.4. The film was corona treated to 40 dynes and printed. The Mxsite™-containing outer layer had a thickness of 0.4 mil, the core layer had a thickness of 1.2 mil and the second outer layer had a thickness of 0.4 mil.

### Example 2

### Adhesion Strength Testing

The substrate used in for testing the adhesion strength of the masking film was a transparent corrugated polycarbonate (PC) produced by GE named Verolite®. Such testing could also be performed using other substrates such as other PC, PMMA, PS, ABS, PET, PET-G and glass as well as other surface aspects such as smooth, matte, embossed, corrugate d or else.

A masking film of the present invention was tested and compared to four films (Comparative Films 1-4) having the compositions outlined in the following table. All of the films were blown extruded using standard techniques and laminated to the substrate using the apparatus depicted in FIG. 2. Adhesion of the Comparative Films 2, 3 and 4 to the substrate was achieved only once the films reached 80° C. as measured by an infra red sensor.

| Masking Film | Comparative | Comparative | Comparative | Comparative |
|---|---|---|---|---|
| (Example 1) | Film 1 | Film 2 | Film 3 | Film 4 |
| Three Layer Film | Three Layer Film | Mono-layer | LDPE low slip | PE high slip |
| A: Eastman | A: 65% Westlake | 100% AT | corona treated, | corona untreated, |
| MXSITE 78102 | 561AV low slip; | PLASTICS | Mono-layer | Mono-layer |
| B: 100% | 35% Equistar | ATEVA 1811 | LDPE Eastman | TSR 15620 |
| Eastman Hifor | EVA X0911; | (EVA 18%) | 969 low slip; | 20%: 819D high |
| C: LDPE Dow | 5% HM-10 | totally barefoot | corona treated | slip; |
| 494 | B: 100% Eastman | | to 40 dynes | 80%: 1107R high |
| | 24803 | | | slip |
| | C: LDPE | | | |
| | Eastman 969 low | | | |
| | slip; corona | | | |
| | treated to 40 | | | |
| | dynes | | | |

A “block-reblock tester” can be used to perform a test to confirm that a masking film according to the present invention is suitable for use in protecting a surface of a substrate. In other words the “block-reblock tester” can be used in a “Go-No go” test. The block-reblock tester is an apparatus designed to evaluate blockings of films by measuring the force required to separate two blocked film surfaces. Generally, the tester is used by mechanically attaching two 4″×4″ strips of plastic film to either platen of the tester. A vertical pull force is applied to the top platen while the bottom platen remains immobile. The force required to separate the two films is measured and recorded. In the present application a block-reblock tester, manufactured by Kayeness, Inc, Honey Brook, Pa. 19344, was adapted to measure the force required to separate a film-substrate composite.

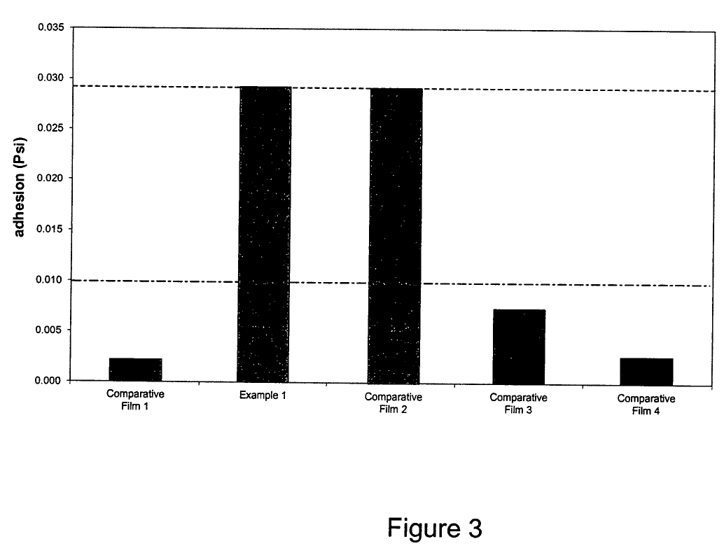

The five films listed above were tested using the modified block-reblock tester. The force in grams was re-expressed in Psi as shown in FIG. 3. This graph shows that the masking film prepared according to Example 1 (“Masking Film”) and the Comparative Film 2 both exhibit excellent tackiness on the PC substrate whereas the other comparative films were not appropriate for use as protective masking films. An value of 0.01 Psi was identified as being an appropriate empirical threshold for primary tackiness of the film to the PC substrate.

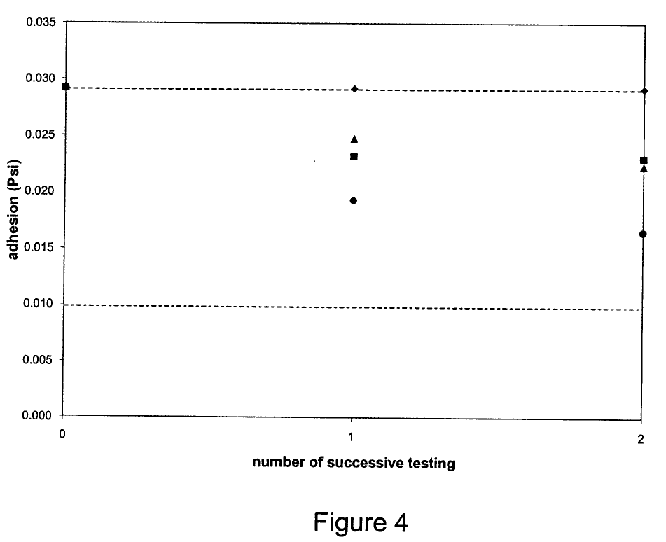

The effect of successive peelings and re-laminating conditions is depicted in FIG. 4. Re-laminating was performed by applying the film to be tested to the PC substrate using rolls of different weights through a rubber layer. The weights of the roll used for applying constant pressure were 14.5, 10.8 and 4.5 lbs. The term “no pressure”, as used in FIG. 4, indicates that the film was manually re-laminated to the substrate. As depicted in FIG. 4, the use of higher pressure to laminate, or re-laminate, the film to the substrate results in stronger adhesion of the film to the substrate.

Another testing procedure was used to compare the adhesion strength between the films listed above and the substrate. The test was designed based on the fact that a lower peeling velocity is indicative of a stronger adhesion. In this test the first step is to cut a strip of the composite formed from a film laminated to a surface of a substrate and subsequently attach a weight to the film at one end of the strip. The strip is then held in place in such a manner as to allow the film to peel from the substrate as a result of the effect of gravity on the weight hanging from the end of the film.

The peeling velocity was found to remain relatively constant over the peeling length of 6 to 8 inches. This indicates that the additional weight from the peeled film can be ignored when calculating the peeling velocity.

All of the films listed in the table above were tested using this methodology. Comparative Films 1, 3 and 4 exhibited instantaneous peeling of an 8″ strip when using a 5 g weight. In contrast, the Masking Film and the Comparative Film 2 had measurable peeling velocities when calculating the velocity from the peeling of an 8″ strip of film from the strip of composite using a 5 g weight. The testing was performed both in transversal and longitudinal directions, thereby taking into account the anisotropy of the corrugated PC substrate. To correct for the experimental standard of deviation, this peeling velocity test was performed using different zones of the substrate and different lots of the films. The films were re-laminated manually taking care to avoid any air bubbles entrapped between the film and the substrate.

In the transversal direction:

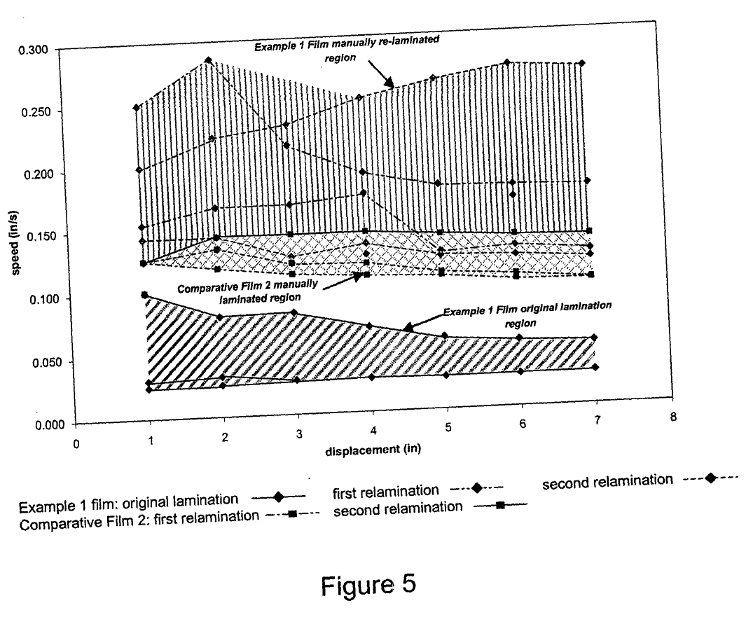

The original lamination for the masking film, prepared as described in Example 1, was performed using a rubberized laminator as depicted in FIG. 2. A slight loss of adhesion at each re-lamination of the Masking Film was observed, however, this film exhibited excellent re-wettability as shown in FIG. 5. As a reference in term of tackiness, a monolayer of EVA 18% (Comparative Film 2) showed slightly better adhesion in transversal peeling direction.

In the longitudinal direction:

Masking film, prepared as described in Example 1, was laminated to the substrate using a laminator as depicted in FIG. 2. The film exhibited similar tackiness in the longitudinal direction as observed in the transversal direction. In other words, the peeling velocity was very similar to the one obtained in transversal direction. These studies were done on corrugated plastic sheets which have a streak or indentation in the longitudinal direction. This observation indicates that the indentation in the sheet had no effect on adhesion. Adhesion of the Masking Film on the substrate was found to be better than that of the EVA 18% monolayer film (Comparative Film 2).

Experimental Procedure for Determination of Peeling Velocity

Preparation:

Cut a 1″ strip of laminated masking film on one side of the substrate over at least 10 inches length;

Mark the substrate at regular intervals (e.g. 1″) along the strip;

Attach a 5 g weight to one end of the strip to be peeled using adhesive tape, or the like;

Measurement:

Allow the strip to be peeled under constant stress of 5 g weight;

Start measuring time as the film peels past the first mark and record time every inch i.e. when the film peels past each regularly spaced mark;

Calculate the cumulative peeling velocity all along at least 6 inches of peeled strip as follows:

velocity (in/s)=total displacement (in)/cumulative time(s)

Repeat the measurement for 4 or more strips to confirm consistency.

The Masking Film exhibited excellent tackiness on PC corrugated substrate. It also showed excellent re-wettability similar to the more expensive EVA 18% monolayer film.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An adhesiveless masking film, comprising a first outer layer consisting of Mxsite™ and a second outer layer that does not contain Mxsite™, wherein the first outer layer of the film is adapted for retackably adhering to a surface of a substrate.

2. The masking film according to claim 1, wherein the second outer layer comprises low density polyethylene, linear low density polyethylene, medium density polyethylene, high density polyethylene, polypropylene, ethylene vinyl acetate or a mixture thereof.

3. The masking film according to claim 1, which comprises one or more inner layers.

4. The masking film according to claim 3, wherein each of the one or more inner layers comprises low density polyethylene, linear low density polyethylene, medium density polyethylene, high density polyethylene, polypropylene, ethylene vinyl acetate or a mixture thereof.

5. The masking film according to claim 3, wherein each of the one or more inner layers comprises Mxsite™.

6. The masking film according to claim 1, which is a coextruded cast or blown film.

7. The masking film according to claim 1, wherein the film consists of three layers.

8. The masking film according to claim 7, wherein the second outer layer consists of low density polyethylene and the middle layer consists of an advanced Zeigler Natta catalyzed linear low density polyethylene.

9. The masking film according to claim 8, wherein the low density polyethylene is Dow 494™ and the advanced Zeigler Natta catalyzed linear low density polyethylene is Eastman Hifor™.

10. The masking film according to claim 1, wherein the second outer layer additionally comprises a slip agent.

11. The masking film according to claim 10, wherein the slip agent is present in an amount greater than 200 ppm.

12. The masking film according to claim 10, wherein the slip agent is euricamide.

13. Use of Mxsite™ in the manufacture of an adhesiveless masking film according to claim 1.

14. Use of an adhesiveless masking film according to claim 1, to protect the surface of the substrate.

15. The use according to claim 14, wherein the substrate is a smooth or corrugated sheet of polycarbonate, polyester, glycol modified copolyester, acrylic, polystyrene, acrylomitrile-butadiene-styrene, or glass.

16. A method for measuring adhesion of a film to a substrate comprising the steps of:
(a) laminating the film to a surface of the substrate to produce a laminated film composite;
(b) cutting a strip of the laminated film composite having a predetermined length;
(c) marking the strip of laminated film composite at regular intervals along the length of the strip;
(d) attaching a weight to the film at one end of the strip;
(e) allowing the film to peel off of the substrate under constant stress of a weight;
(f) determining time required for the film to be displaced from the composite by measuring the time for the film to peel off the substrate to each mark on the strip;
(g) calculating a cumulative peeling velocity by dividing the length of total displacement of the film with the sum of the times measured in step (f),
wherein the strength of adhesion of the film to the substrate is a function of the cumulative peeling velocity.

17. The method according to claim 16, wherein the predetermined length of the strip is at least 10 inches.

18. The method according to claim 16, wherein the marks made in step (c) are at intervals of 1 inch.

19. The method according to claim 16, wherein the weight is a 5 g weight.
